(19) United States
(12) Patent Application Publication
(10) Pub. No.: US 2025/0212271 A1
(43) Pub. Date: Jun. 26, 2025

(54) METHOD FOR ADVERTISING EXTENDED ADVERTISING PACKET, METHOD FOR RECEIVING EXTENDED ADVERTISING PACKET, COMMUNICATIONS SYSTEM, AND RELATED DEVICE

(71) Applicant: AMLOGIC (SHANGHAI) CO., LTD., Shanghai (CN)

(72) Inventors: Yuyin ZHANG, Shanghai (CN); Xiaoyong ZHOU, Shanghai (CN)

(21) Appl. No.: 18/942,158

(22) Filed: Nov. 8, 2024

(30) Foreign Application Priority Data
Dec. 22, 2023 (CN) 202311790111.2

(51) Int. Cl. H04W 76/14; H04W 8/00; H04W 84/18

(52) U.S. Cl. CPC H04W 76/14; H04W 8/005; H04W 84/18

(57) ABSTRACT

A method for advertising an extended advertising packet, a method for receiving an extended advertising packet, a communications system, and a related device are disclosed. In the method for advertising an extended advertising packet and the method for receiving an extended advertising packet, an extended advertising packet generated by a Bluetooth advertising device carries information about receiving time and a receiving channel for an auxiliary advertising packet. A Bluetooth receiving device may obtain both an advertising packet type of the auxiliary advertising packet and the information about the receiving time and the receiving channel for the auxiliary advertising packet based on the information about the receiving time and the receiving channel for the auxiliary advertising packet that is obtained by parsing the extended advertising packet, to accurately receive the auxiliary advertising packet.

### TECHNICAL FIELD

Embodiments of the present disclosure relate to the human detection field, and in particular, to a method for advertising an extended advertising packet, a method for receiving an extended advertising packet, a communications system, and a related device.

### BACKGROUND

Bluetooth Low Energy (BLE) communication uses a Gaussian frequency shift keying (GFSK) modulation mode and operates on an industrial, scientific, and medical (ISM) frequency band of 2.4 GHz, with a frequency range of 2.400 GHz to 2.4835 GHz. The ISM frequency band is divided into 40 channels (f=2402+k×2 MHz, k=0, 1, . . . , 39), and a spacing between adjacent channels is 2 MHz. Three primary advertising physical channels exist: a channel 37 with a frequency of 2402 MHz, a channel 38 with a frequency of 2426 MHz, and a channel 39 with a frequency of 2480 MHz. Secondary advertising physical channels are 37 channels of the 40 channels other than the primary advertising physical channels.

The Bluetooth 5.0 specification is a new specification proposed by the Bluetooth Special Interest Group in December 2012. An important one of many new features that are proposed is enhancement of connectionless advertising communication. Specifically, advertising in the Bluetooth 5.0 specification supports transmission of a large amount of data, and supports linked transmission, so that a data amount in Bluetooth communication can be increased from 31 bytes to 1650 bytes. In addition, advertising packet transmission channels in the Bluetooth 5.0 specification are also extended from original three primary advertising physical channels to 40 available Bluetooth channels.

However, receiving accuracy is low in a current method for transmitting an extended advertising packet.

### SUMMARY

A problem to be resolved in embodiments of the present disclosure is to provide a method for advertising an extended advertising packet, a method for receiving an extended advertising packet, a communications system, and a related device, to improve accuracy for receiving an extended advertising packet.

To resolve the foregoing problem, embodiments of the present disclosure provide a method for advertising an extended advertising packet, applicable to a Bluetooth advertising device, and including:
generating an extended advertising packet, the extended advertising packet carrying information about receiving time and a receiving channel for an auxiliary advertising packet;
advertising the extended advertising packet in a primary advertising physical channel, so that in the case of successfully receiving the extended advertising packet, a Bluetooth receiving device parses the extended advertising packet to obtain the information about the receiving time and the receiving channel for the auxiliary advertising packet that is carried in the extended advertising packet;
generating the auxiliary advertising packet; and
advertising the auxiliary advertising packet based on the information about the receiving time and the receiving channel for the auxiliary advertising packet, so that the Bluetooth receiving device receives the auxiliary advertising packet based on the information about the receiving time and the receiving channel for the auxiliary advertising packet that is obtained by parsing the extended advertising packet.

In some embodiments, the extended advertising packet includes a first Aux Ptr field, and the first Aux Ptr field is used for identifying the information about the receiving time and the receiving channel for the auxiliary advertising packet.

In some embodiments, the auxiliary advertising packet carries information about receiving time and a receiving channel for at least one of a synchronous advertising packet and a chain advertising packet, and the advertising method further includes at least one of the following operations:
generating the synchronous advertising packet; advertising the synchronous advertising packet based on information about receiving time and a receiving channel for the synchronous advertising packet, so that the Bluetooth receiving device receives the synchronous advertising packet based on the information about the receiving time and the receiving channel for the synchronous advertising packet;
generating the chain advertising packet; and advertising the chain advertising packet based on information about receiving time and a receiving channel for the chain advertising packet, so that the Bluetooth receiving device receives the chain advertising packet based on the information about the receiving time and the receiving channel for the chain advertising packet.

In some embodiments, the auxiliary advertising packet includes a second Aux Ptr field and a Sync Info field, the second Aux Ptr field is used for identifying the information about the receiving time and the receiving channel for the chain advertising packet, and the Sync Info field is used for identifying the information about the receiving time and the receiving channel for the synchronous advertising packet.

In some embodiments, the receiving channel for the synchronous advertising packet is different from the receiving channel for the auxiliary advertising packet.

In some embodiments, one or more chain advertising packets exist; and
in a case that a plurality of chain advertising packets exist, receiving channels for some or all of the chain advertising packets are the same as the receiving channel for the auxiliary advertising packet, or receiving channels for some or all of the chain advertising packets are the same as the receiving channel for the synchronous advertising packet.

In some embodiments, the extended advertising packet is a scannable extended advertising packet, and the auxiliary advertising packet is a scannable auxiliary advertising packet; and
the advertising method further includes: receiving a scan request for the auxiliary advertising packet from the Bluetooth receiving device; generating a scan response corresponding to the scan request; and advertising the scan response in the receiving channel for the auxiliary advertising packet, so that the Bluetooth receiving device receives the scan response in the receiving channel for the auxiliary advertising packet.

In some embodiments, the extended advertising packet is a connectable extended advertising packet, and the auxiliary advertising packet is a scannable auxiliary advertising packet; and
the advertising method further includes: receiving a connect request for the auxiliary advertising packet from the Bluetooth receiving device; generating a connect response corresponding to the connect request; and advertising the connect response in the receiving channel for the auxiliary advertising packet, so that the Bluetooth receiving device receives the connect response in the receiving channel for the auxiliary advertising packet.

Correspondingly, embodiments of the present disclosure further provide a method for receiving an extended advertising packet, applicable to a Bluetooth receiving device, and including:
monitoring a primary advertising physical channel to obtain an extended advertising packet that is advertised by a Bluetooth advertising device, the extended advertising packet carrying information about receiving time and a receiving channel for an auxiliary advertising packet;
parsing the extended advertising packet to obtain the information about the receiving time and the receiving channel for the auxiliary advertising packet that is carried in the extended advertising packet; and
receiving the auxiliary advertising packet based on the information about the receiving time and the receiving channel for the auxiliary advertising packet that is obtained through parsing.

In some embodiments, the extended advertising packet includes a first Aux Ptr field, and the first Aux Ptr field is used for identifying the information about the receiving time and the receiving channel for the auxiliary advertising packet.

In some embodiments, the auxiliary advertising packet carries information about receiving time and a receiving channel for at least one of a synchronous advertising packet and a chain advertising packet; and
in a case that the auxiliary advertising packet is successfully received, the receiving method further includes at least one of the following operations:
parsing the auxiliary advertising packet to obtain information about receiving time and a receiving channel for the synchronous advertising packet that is carried in the auxiliary advertising packet; receiving the synchronous advertising packet based on the information about the receiving time and the receiving channel for the synchronous advertising packet that is obtained through parsing;
parsing the auxiliary advertising packet to obtain information about receiving time and a receiving channel for the chain advertising packet; and receiving the chain advertising packet based on the information about the receiving time and the receiving channel for the chain advertising packet that is obtained through parsing.

In some embodiments, the auxiliary advertising packet includes a second Aux Ptr field and a Sync Info field, the second Aux Ptr field is used for identifying the information about the receiving time and the receiving channel for the chain advertising packet, and the Sync Info field is used for identifying the information about the receiving time and the receiving channel for the synchronous advertising packet.

In some embodiments, the receiving channel for the synchronous advertising packet is different from the receiving channel for the auxiliary advertising packet.

In some embodiments, one or more chain advertising packets exist; and
receiving channels for some or all of the chain advertising packets are the same as the receiving channel for the auxiliary advertising packet, or receiving channels for some or all of the chain advertising packets are the same as the receiving channel for the synchronous advertising packet.

In some embodiments, in a case that the receiving channel for the chain advertising packet is the same as the receiving channel for the synchronous advertising packet, the receiving time for the chain advertising packet is later than the receiving time for the synchronous advertising packet.

In some embodiments, the receiving method further includes: obtaining, based on information about receiving time, a receiving channel, and a protocol data component type for at least one of the extended advertising packet and the auxiliary advertising packet, information about belong-to advertising sets corresponding to the auxiliary advertising packet to which the extended advertising packet is directed and at least one of the synchronous advertising packet and the chain advertising packet to which the auxiliary advertising packet is directed; and receiving, by using the corresponding belong-to advertising sets, the auxiliary advertising packet to which the extended advertising packet is directed and at least one of the synchronous advertising packet and the chain advertising packet to which the auxiliary advertising packet is directed.

In some embodiments, the receiving method further includes:
transmitting corresponding advertising packet receiving result prompt information to a corresponding advertising set creator based on receiving results for the auxiliary advertising packet to which the extended advertising packet is directed and at least one of the synchronous advertising packet and the chain advertising packet to which the auxiliary advertising packet is directed.

In some embodiments, the extended advertising packet is a scannable extended advertising packet, and the auxiliary advertising packet is a scannable auxiliary advertising packet; and
in a case that the auxiliary advertising packet is successfully received, the receiving method further includes: transmitting a corresponding scan request to the Bluetooth advertising device for the auxiliary advertising packet; and receiving a scan response corresponding to the scan request in the receiving channel for the auxiliary advertising packet.

In some embodiments, the extended advertising packet is a connectable extended advertising packet, and the auxiliary advertising packet is a connectable auxiliary advertising packet; and
in a case that the auxiliary advertising packet is successfully received, the method further includes: transmitting a corresponding connect request to the Bluetooth advertising device for the auxiliary advertising packet; and receiving a connect response corresponding to the connect request in the receiving channel for the auxiliary advertising packet.

Correspondingly, embodiments of the present disclosure further provide a Bluetooth advertising device, including:
a generation component, configured to generate an extended advertising packet, the extended advertising packet carrying information about receiving time and a receiving channel for an auxiliary advertising packet; and further configured to generate the auxiliary advertising packet; and
an advertising component, configured to advertise the extended advertising packet in a primary advertising physical channel, so that in the case of successfully receiving the extended advertising packet, a Bluetooth receiving device parses the extended advertising packet to obtain the information about the receiving time and the receiving channel for the auxiliary advertising packet that is carried in the extended advertising packet; and further configured to advertise the auxiliary advertising packet based on the information about the receiving time and the receiving channel for the auxiliary advertising packet, so that the Bluetooth receiving device receives the auxiliary advertising packet based on the information about the receiving time and the receiving channel for the auxiliary advertising packet that is obtained by parsing the extended advertising packet.

Correspondingly, embodiments of the present disclosure further provide a Bluetooth receiving device, including:
an obtaining component, configured to monitor a primary advertising physical channel to obtain an extended advertising packet that is advertised by a Bluetooth advertising device, the extended advertising packet carrying information about receiving time and a receiving channel for an auxiliary advertising packet;
a parsing component, configured to parse the extended advertising packet to obtain the information about the receiving time and the receiving channel for the auxiliary advertising packet that is carried in the extended advertising packet; and
a receiving component, configured to receive the auxiliary advertising packet based on the information about the receiving time and the receiving channel for the auxiliary advertising packet that is obtained through parsing.

Correspondingly, embodiments of the present disclosure further provide a communications system, including the foregoing Bluetooth advertising device, and the foregoing Bluetooth receiving device.

Correspondingly, embodiments of the present disclosure further provide an electronic device, including at least one memory and at least one processor. The memory stores one or more computer instructions. The one or more computer instructions are executed by the processor to implement the method for advertising an extended advertising packet according to any one of the foregoing implementations, or the method for receiving an extended advertising packet according to any one of the foregoing implementations.

Correspondingly, embodiments of the present disclosure further provide a storage medium. The storage medium stores one or more computer instructions. The one or more computer instructions are used for implementing the method for advertising an extended advertising packet according to any one of the foregoing implementations, or the method for receiving an extended advertising packet according to any one of the foregoing implementations.

Compared with the related art, the technical solutions in embodiments of the present disclosure have the following advantages:

Embodiments of the present disclosure provide a method for advertising an extended advertising packet, including: generating an extended advertising packet, the extended advertising packet carrying information about receiving time and a receiving channel for an auxiliary advertising packet; and advertising the extended advertising packet in a primary advertising physical channel, so that in the case of successfully receiving the extended advertising packet, a Bluetooth receiving device parses the extended advertising packet to obtain the information about the receiving time and the receiving channel for the auxiliary advertising packet that is carried in the extended advertising packet, and receives the auxiliary advertising packet based on the information about the receiving time and the receiving channel for the auxiliary advertising packet that is obtained through parsing.

Correspondingly, embodiments of the present disclosure provide a method for receiving an extended advertising packet, including: monitoring a primary advertising physical channel to obtain an extended advertising packet that is advertised by a Bluetooth advertising device, the extended advertising packet carrying information about receiving time and a receiving channel for an auxiliary advertising packet; parsing the extended advertising packet to obtain the information about the receiving time and the receiving channel for the auxiliary advertising packet that is carried in the extended advertising packet; and receiving the auxiliary advertising packet based on the information about the receiving time and the receiving channel for the auxiliary advertising packet that is obtained through parsing.

In the method for advertising an extended advertising packet and the method for receiving an extended advertising packet in embodiments of the present disclosure, an extended advertising packet generated by a Bluetooth advertising device carries information about receiving time and a receiving channel for an auxiliary advertising packet. In this way, a Bluetooth receiving device can obtain both an advertising packet type of the auxiliary advertising packet and the information about the receiving time and the receiving channel for the auxiliary advertising packet based on the information about the receiving time and the receiving channel for the auxiliary advertising packet that is obtained by parsing the extended advertising packet, to accurately receive the auxiliary advertising packet.

Further, the auxiliary advertising packet generated by the Bluetooth advertising device carries information about receiving time and a receiving channel for at least one of a synchronous advertising packet and a chain advertising packet. In this way, the Bluetooth receiving device can obtain both an advertising packet type of the synchronous advertising packet and information about receiving time and a receiving channel for the synchronous advertising packet, and/or both an advertising packet type of the chain advertising packet and information about receiving time and a receiving channel for the chain advertising packet based on the information about the receiving time and the receiving channel for at least one of the synchronous advertising packet and the chain advertising packet that is obtained by parsing the auxiliary advertising packet, to accurately receive the synchronous advertising packet and the chain advertising packet.

### BRIEF DESCRIPTION OF THE DRAWINGS

FIG. 1 is a schematic structural diagram of an embodiment of a communications system according to a technical solution of the present disclosure.

FIG. 2 is a schematic diagram of linked propagation for an extended advertising packet according to a technical solution of the present disclosure.

FIG. 3 is a schematic flowchart of an embodiment of a method for advertising an extended advertising packet according to a technical solution of the present disclosure.

FIG. 4 is a schematic flowchart of an embodiment of a method for receiving an extended advertising packet according to a technical solution of the present disclosure.

FIG. 5 is a schematic flowchart of scanning-based communication between a Bluetooth advertising device and a Bluetooth receiving device according to a technical solution of the present disclosure.

FIG. 6 is a schematic flowchart of connection-based communication between a Bluetooth advertising device and a Bluetooth receiving device according to a technical solution of the present disclosure.

FIG. 7 is a schematic diagram of correspondences between advertising events and advertising sets that correspond to extended advertising packets.

FIG. 8 is a schematic structural diagram of an embodiment of a Bluetooth advertising device according to a technical solution of the present disclosure.

FIG. 9 is a schematic structural diagram of an embodiment of a Bluetooth receiving device according to a technical solution of the present disclosure.

FIG. 10 is a schematic diagram of an exemplary hardware structure of an electronic device according to an embodiment of the present disclosure.

### DETAILED DESCRIPTION

Receiving accuracy is low in a current method for transmitting an extended advertising packet.

To resolve the foregoing technical problem, embodiments of the present disclosure provide a method for advertising an extended advertising packet, including: generating an extended advertising packet, the extended advertising packet carrying information about receiving time and a receiving channel for an auxiliary advertising packet; and advertising the extended advertising packet in a primary advertising physical channel, so that in the case of successfully receiving the extended advertising packet, a Bluetooth receiving device parses the extended advertising packet to obtain the information about the receiving time and the receiving channel for the auxiliary advertising packet that is carried in the extended advertising packet, and receives the auxiliary advertising packet based on the information about the receiving time and the receiving channel for the auxiliary advertising packet that is obtained through parsing.

Correspondingly, embodiments of the present disclosure provide a method for receiving an extended advertising packet, including: monitoring a primary advertising physical channel to obtain an extended advertising packet that is advertised by a Bluetooth advertising device, the extended advertising packet carrying information about receiving time and a receiving channel for an auxiliary advertising packet; parsing the extended advertising packet to obtain the information about the receiving time and the receiving channel for the auxiliary advertising packet that is carried in the extended advertising packet; and receiving the auxiliary advertising packet based on the information about the receiving time and the receiving channel for the auxiliary advertising packet that is obtained through parsing.

In the method for advertising an extended advertising packet and the method for receiving an extended advertising packet in embodiments of the present disclosure, an extended advertising packet generated by a Bluetooth advertising device carries information about receiving time and a receiving channel for an auxiliary advertising packet. In this way, a Bluetooth receiving device can obtain both an advertising packet type of the auxiliary advertising packet and the information about the receiving time and the receiving channel for the auxiliary advertising packet based on the information about the receiving time and the receiving channel for the auxiliary advertising packet that is obtained by parsing the extended advertising packet, to accurately receive the auxiliary advertising packet.

To make the foregoing objectives, features, and advantages of the present disclosure clearer and easier to understand, specific embodiments of the present disclosure are described in detail below with reference to the accompanying drawings.

For ease of understanding, a communications system in embodiments of the present disclosure is first described.

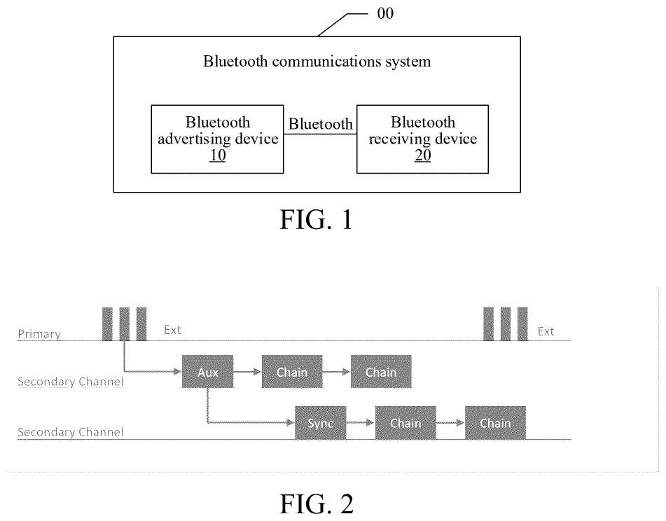

FIG. 1 is a schematic structural diagram of an embodiment of a communications system according to a technical solution of the present disclosure. As shown in FIG. 1, the communications system 00 may include a Bluetooth advertising device 10, and the Bluetooth advertising device 10 is a device with a Bluetooth advertising capability.

In this embodiment, the Bluetooth advertising device 10 serves as an advertising end for an advertising packet, and is configured to generate an extended advertising packet including an extended advertising packet, an auxiliary advertising packet to which the extended advertising packet is directed, a synchronous advertising packet and/or a chain advertising packet to which the auxiliary advertising packet is directed, and advertise the generated extended advertising packet including the extended advertising packet, the auxiliary advertising packet to which the extended advertising packet is directed, the synchronous advertising packet and/or the chain advertising packet to which the auxiliary advertising packet is directed.

In practical application, the Bluetooth advertising device 10 may be a communications device with a Bluetooth circuit or a Bluetooth chip, for example, a personal computer (PC), a personal digital assistant (PDA), a smartphone, a smart speaker, or a smart television.

The communications system 00 further includes a Bluetooth receiving device 20, and the Bluetooth receiving device 20 is a device with a Bluetooth receiving capability.

Specifically, the Bluetooth receiving device 20 serves as a receiving end for an advertising packet, and is configured to receive an extended advertising packet including an extended advertising packet, an auxiliary advertising packet to which the extended advertising packet is directed, and a synchronous advertising packet and/or a chain advertising packet to which the auxiliary advertising packet is directed, and receive, through a corresponding advertising physical channel, the extended advertising packet that is advertised by the Bluetooth advertising device 10 and that includes the extended advertising packet, the auxiliary advertising packet to which the extended advertising packet, and the synchronous advertising packet and/or the chain advertising packet to which the auxiliary advertising packet is directed.

In practical application, the Bluetooth receiving device 20 may be a communications device with a Bluetooth circuit or a Bluetooth chip, for example, a personal computer, a tablet computer, a smartphone, a smart speaker, or a smart television.

The Bluetooth advertising device 10 and the Bluetooth receiving device 20 are only functional roles obtained by classifying Bluetooth devices with a Bluetooth communication function from a perspective of advertising an advertising packet and a perspective of receiving an advertising packet. It can be understood by a person skilled in the art that, during Bluetooth communication, the Bluetooth advertising device 10 may alternatively serve as a receiving end for an advertising packet to receive an advertising packet advertised by another Bluetooth communications device, and the Bluetooth receiving device 20 may alternatively be serve as an advertising end for an advertising packet to generate and advertise an advertising packet.

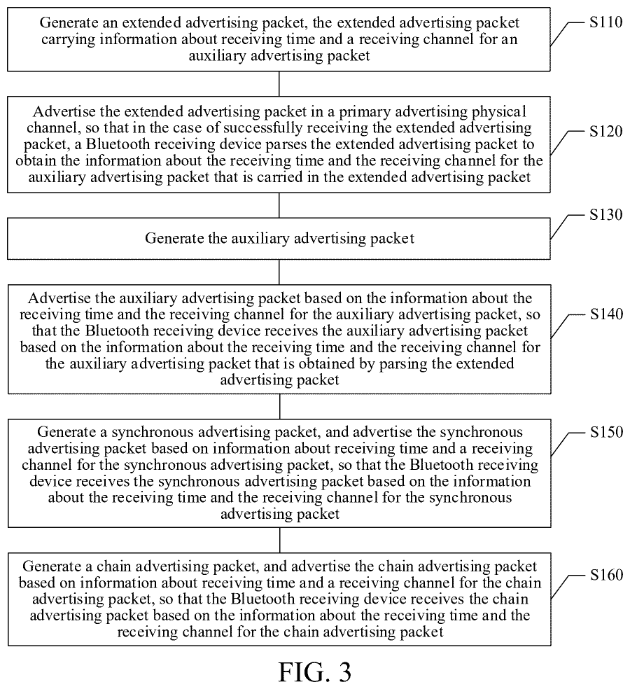

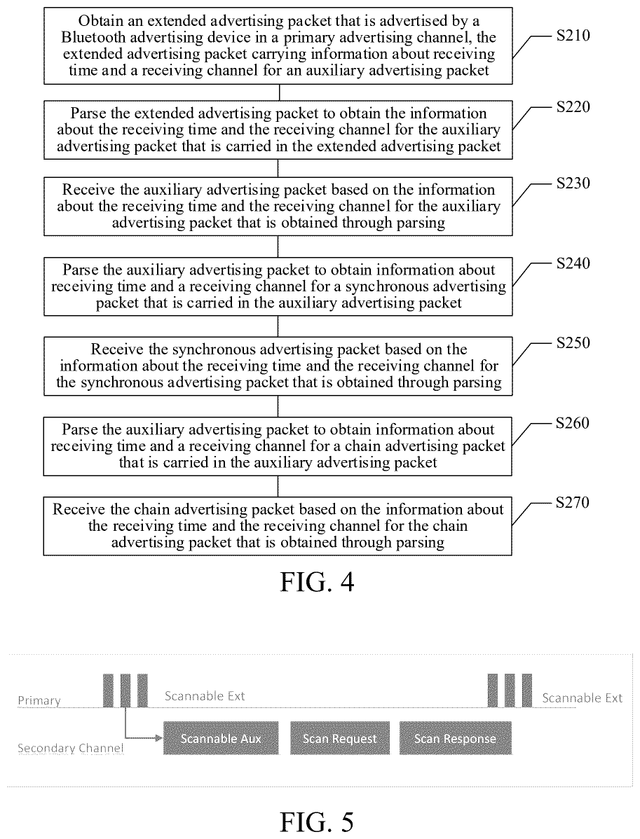

FIG. 2 is a schematic diagram of linked propagation for an extended advertising packet according to a technical solution of the present disclosure. FIG. 3 is a schematic flowchart of an embodiment of a method for advertising an extended advertising packet according to a technical solution of the present disclosure. FIG. 4 is a schematic flowchart of an embodiment of a method for receiving an extended advertising packet according to a technical solution of the present disclosure.

With reference to FIG. 1 to FIG. 4, a method for advertising an extended advertising packet is applicable to the Bluetooth advertising device 10, and may specifically include the following steps:
Step S110: Generate an extended advertising packet, the extended advertising packet carrying information about receiving time and a receiving channel for an auxiliary advertising packet.
Step S120: Advertise the extended advertising packet in a primary advertising physical channel, so that in the case of successfully receiving the extended advertising packet, a Bluetooth receiving device parses the extended advertising packet to obtain the information about the receiving time and the receiving channel for the auxiliary advertising packet that is carried in the extended advertising packet.
Step S130: Generate the auxiliary advertising packet.
Step S140: Advertise the auxiliary advertising packet based on the information about the receiving time and the receiving channel for the auxiliary advertising packet, so that the Bluetooth receiving device receives the auxiliary advertising packet based on the information about the receiving time and the receiving channel for the auxiliary advertising packet that is obtained by parsing the extended advertising packet.

Still with reference to FIG. 1 to FIG. 4, step S110 is performed to generate the extended advertising packet, the extended advertising packet carrying the information about the receiving time and the receiving channel for the auxiliary advertising packet.

The Bluetooth advertising device 10 generates the extended advertising packet to prepare for subsequently advertising the extended advertising packet in a primary advertising physical channel.

The extended advertising packet, also referred to as an extended advertising protocol data component (Ext Adv PDU), is an extended advertising packet advertised in the primary advertising physical channel. The primary advertising physical channel includes a channel 37, a channel 38, and a channel 39 of available Bluetooth advertising physical channels.

The auxiliary advertising packet, also referred to as an auxiliary advertising protocol data component (Aux Adv PDU), is an extended advertising packet advertised in a secondary advertising physical channel. The secondary advertising physical channel includes a channel 0 to a channel 36 of the available Bluetooth advertising physical channels.

In this embodiment, the extended advertising packet carries the information about the receiving time and the receiving channel for the auxiliary advertising packet. Specifically, the extended advertising packet includes a first Aux Ptr field, and the first Aux Ptr field is used for identifying the information about the receiving time and the receiving channel for the auxiliary advertising packet.

In this embodiment, the first Aux Ptr field is set in an Extended Header field of the extended advertising packet, so that the Bluetooth receiving device 20 can subsequently quickly obtain the information about the receiving time and the receiving channel for the auxiliary advertising packet.

In this embodiment, in the first Aux Ptr field, the receiving time for the auxiliary advertising packet that is carried in the extended advertising packet is identified by both a first Offset Components field and a first Aux Offset field. Specifically, the first Offset Components field is used for identifying duration of an offset component, and the first Aux Offset field is used for identifying the number of offset components in an interval between the receiving time for the auxiliary advertising packet and receiving time for the extended advertising packet. Correspondingly, the receiving time for the auxiliary advertising packet may be obtained by adding the receiving time for the extended advertising packet to a product of a value of the first Offset Components field and a value of the first Aux Offset field.

In this embodiment, in the first Aux Ptr field, the receiving channel for the auxiliary advertising packet in the extended advertising packet is identified by a first Channel Index field. Specifically, the first Channel Index field is used for identifying information about a channel index of the receiving channel for the auxiliary advertising packet. Correspondingly, the receiving channel for the auxiliary advertising packet may be determined based on a value of the channel index in the first Channel Index field in the first Aux Ptr field and a correspondence between the channel index and an advertising physical channel.

The extended advertising packet carries the information about the receiving time and the receiving channel for the auxiliary advertising packet. In this way, the Bluetooth receiving device 20 may determine, based on the information about the receiving time and the receiving channel for the auxiliary advertising packet that is obtained by parsing the extended advertising packet, that a type of a to-be-received extended advertising packet is an auxiliary advertising packet, and may determine receiving time and a receiving channel for the to-be-received auxiliary advertising packet, to improve accuracy for receiving the auxiliary advertising packet.

In addition, the extended advertising packet generated by the Bluetooth advertising device 10 carries the information about the receiving time and the receiving channel for the auxiliary advertising packet, so that the Bluetooth receiving device 20 can accurately identify a location of the to-be-received auxiliary advertising packet. This helps minimize time consumption and bandwidth consumption of the Bluetooth receiving device 20 that are caused by scanning, and correspondingly, helps reduce receiving power consumption of the Bluetooth receiving device 20.

The extended advertising packet further carries other information, for example, a protocol data component (PDU) and cyclic redundancy check (CRC) information. Details are not described herein.

Still with reference to FIG. 1 to FIG. 4, step S120 is performed to advertise the extended advertising packet in the primary advertising physical channel, so that in the case of successfully receiving the extended advertising packet, the Bluetooth receiving device parses the extended advertising packet to obtain the information about the receiving time and the receiving channel for the auxiliary advertising packet that is carried in the extended advertising packet.

The Bluetooth advertising device 10 advertises the extended advertising packet in the primary advertising physical channel to provide a basis for subsequently receiving the extended advertising packet by the Bluetooth receiving device 20.

Specifically, the Bluetooth advertising device 10 advertises the extended advertising packet in all primary advertising channels, namely, the channel 37, the channel 38, and the channel 39, so that the Bluetooth receiving device 20 can scan all the primary advertising channels to obtain the extended advertising packet.

Still with reference to FIG. 1 to FIG. 4, step S130 is performed to generate the auxiliary advertising packet.

The Bluetooth advertising device 10 generates the auxiliary advertising packet to provide a basis for subsequently advertising the auxiliary advertising packet based on the information about the receiving time and the receiving channel for the auxiliary advertising packet.

In this embodiment, the auxiliary advertising packet carries information about receiving time and a receiving channel for a synchronous advertising packet.

The synchronous advertising packet, also referred to as a synchronous advertising protocol data component (Sync Adv PDU), is a type of periodic advertising packet, and is used for transmitting information related to a broadcast isochronous group (BIG) and assisting in isochronous synchronization of a plurality of broadcast isochronous streams (BISs) in the broadcast isochronous group.

A periodic advertising connection may be established between the Bluetooth advertising device 10 and the Bluetooth receiving device 20 by using the synchronous advertising packet, so that the Bluetooth advertising device 10 can periodically transmit advertising data to the Bluetooth receiving device 20.

In this embodiment, the auxiliary advertising packet includes a Sync Info field, and the Sync Info field is used for identifying the information about the receiving time and the receiving channel for the synchronous advertising packet.

Specifically, the Sync Info field is set in an Extended Header field in a Payload field of the auxiliary advertising packet, so that the Bluetooth receiving device 20 can subsequently quickly obtain the information about the receiving time and the receiving channel for the synchronous advertising packet.

In this embodiment, in the Sync Info field, the receiving time for the synchronous advertising packet that is carried in the auxiliary advertising packet is identified by both a second Offset Components field and a second Aux Offset field. The second Offset Components field in the auxiliary advertising packet is used for identifying duration of an offset component, and the second Aux Offset field in the auxiliary advertising packet is used for identifying the number of offset components in an interval between the receiving time for the auxiliary advertising packet and the receiving time for the extended advertising packet. Correspondingly, the receiving time for the synchronous advertising packet may be obtained by adding the receiving time for the auxiliary advertising packet to a product of a value of the second Offset Components field and a value of the second Aux Offset field.

In this embodiment, the Sync Info field includes a second Channel Index field, and the receiving channel for the synchronous advertising packet in the auxiliary advertising packet is included in the second Channel Index field. Correspondingly, the receiving channel for the synchronous advertising packet may be determined based on a value of a channel index in the second Channel Index field and a correspondence between the channel index and an advertising physical channel.

The auxiliary advertising packet carries the information about the receiving time and the receiving channel for the synchronous advertising packet. In this way, the Bluetooth receiving device 20 may determine, based on the information about the receiving time and the receiving channel for the synchronous advertising packet that is obtained by parsing the auxiliary advertising packet, that a type of a to-be-received extended advertising packet is a synchronous advertising packet, and may determine receiving time and a receiving channel for the to-be-received synchronous advertising packet, to improve accuracy for receiving the synchronous advertising packet.

In addition, the auxiliary advertising packet generated by the Bluetooth advertising device 10 carries the information about the receiving time and the receiving channel for the synchronous advertising packet, so that the Bluetooth receiving device 20 can accurately identify a location of the to-be-received synchronous advertising packet. This helps minimize time consumption and bandwidth consumption of the Bluetooth receiving device 20 that are caused by scanning the synchronous advertising packet, and correspondingly, helps further reduce receiving power consumption of the Bluetooth receiving device 20.

In this embodiment, the auxiliary advertising packet further carries information about receiving time and a receiving channel for a chain advertising packet.

The chain advertising packet, also referred to as a chain advertising protocol data component (Chain Adv PDU), is used for constituting a chain packet together with the extended advertising packet and the auxiliary advertising packet to which the extended advertising packet is directed, to carry more advertising data. In this way, a larger amount of advertising data can be transmitted between the Bluetooth advertising device 10 and the Bluetooth receiving device 20.

In this embodiment, the auxiliary advertising packet includes a second Aux Ptr field, and the second Aux Ptr field is used for identifying the information about the receiving time and the receiving channel for the chain advertising packet.

The second Aux Ptr field is set in an Extended Header field in a Payload field of the auxiliary advertising packet, so that the Bluetooth receiving device 20 can subsequently quickly obtain the information about the receiving time and the receiving channel for the chain advertising packet.

In this embodiment, in the second Aux Ptr field, the receiving time for the chain advertising packet that is carried in the auxiliary advertising packet is identified by a third Offset Components field and a third Aux Offset field. Specifically, the third Offset Components field is used for identifying duration of an offset component, and the third Aux Offset field is used for identifying the number of offset components in an interval between the receiving time for the chain advertising packet and the receiving time for the auxiliary advertising packet. Correspondingly, the receiving time for the chain advertising packet may be obtained by adding the receiving time for the auxiliary advertising packet to a product of a value of the third Offset Components field and a value of the third Aux Offset field.

In this embodiment, the second Aux Ptr field further includes a third Channel Index field, and information about the receiving channel for the chain advertising packet is set in the third Channel Index field in the second Aux Ptr field. Correspondingly, the receiving channel for the chain advertising packet may be determined based on a value of a channel index in the third Channel Index field in the second Aux Ptr field and a correspondence between the channel index and an advertising physical channel.

The auxiliary advertising packet carries the information about the receiving time and the receiving channel for the chain advertising packet. In this way, the Bluetooth receiving device 20 may determine, based on the information about the receiving time and the receiving channel for the chain advertising packet that is obtained by parsing the auxiliary advertising packet, that a type of a to-be-received extended advertising packet is a chain advertising packet, and may determine receiving time and a receiving channel for the to-be-received chain advertising packet, to improve accuracy for receiving the chain advertising packet.

In addition, the auxiliary advertising packet generated by the Bluetooth advertising device 10 carries the information about the receiving time and the receiving channel for the chain advertising packet, so that the Bluetooth receiving device 20 can accurately identify a location of the to-be-received chain advertising packet. This helps minimize time consumption and bandwidth consumption of the Bluetooth receiving device 20 that are caused by scanning the chain advertising packet, and correspondingly, helps further reduce receiving power consumption of the Bluetooth receiving device 20.

One or more chain advertising packets may exist according to a transmission requirement of advertising data.

In a case that one chain advertising packet exists, the receiving channel for the chain advertising packet may be the same as the receiving channel for the auxiliary advertising packet, or the receiving channel for the chain advertising packet may be the same as the receiving channel for the synchronous advertising packet, or the receiving channel for the chain advertising packet is different from the receiving channel for the auxiliary advertising packet and the receiving channel for the synchronous advertising packet.

In some implementations, in a case that a plurality of chain advertising packets exist, receiving channels for some of the chain advertising packets may be the same as the receiving channel for the auxiliary advertising packet, and a receiving channel for a remaining chain advertising packet is the same as the receiving channel for the synchronous advertising packet.

In other embodiments, the auxiliary advertising packet may alternatively carry only the information about the receiving time and the receiving channel for the synchronous advertising packet, or the auxiliary advertising packet may alternatively carry only the information about the receiving time and the receiving channel for the chain advertising packet. This is not limited.

With reference to FIG. 1 to FIG. 4, step S140 is performed to advertise the auxiliary advertising packet based on the information about the receiving time and the receiving channel for the auxiliary advertising packet, so that the Bluetooth receiving device receives the auxiliary advertising packet based on the information about the receiving time and the receiving channel for the auxiliary advertising packet that is obtained by parsing the extended advertising packet.

The Bluetooth advertising device 10 advertises the auxiliary advertising packet based on the information about the receiving time and the receiving channel for the auxiliary advertising packet, to provide a basis for subsequently receiving, by the Bluetooth receiving device 20, the auxiliary advertising packet based on the information about the receiving time and the receiving channel for the auxiliary advertising packet that are obtained through parsing.

In this embodiment, the auxiliary advertising packet further carries the information about the receiving time and the receiving channel for the synchronous advertising packet.

Correspondingly, after the auxiliary advertising packet is advertised based on the information about the receiving time and the receiving channel for the auxiliary advertising packet, the method for advertising an extended advertising packet further includes the following step: Step S150 is performed to generate the synchronous advertising packet, and advertise the synchronous advertising packet based on the information about the receiving time and the receiving channel for the synchronous advertising packet, so that the Bluetooth receiving device receives the synchronous advertising packet based on the information about the receiving time and the receiving channel for the synchronous advertising packet.

The Bluetooth advertising device 10 generates the synchronous extended packet, and advertises the synchronous extended packet based on the information about the receiving time and the receiving channel for the synchronous extended packet. In this way, the Bluetooth receiving device 20 can subsequently receive the synchronous advertising packet based on the information about the receiving time and the receiving channel for the synchronous advertising packet that is obtained through parsing.

In this embodiment, the auxiliary advertising packet further carries the information about the receiving time and the receiving channel for the chain advertising packet.

Correspondingly, after the auxiliary advertising packet is advertised based on the information about the receiving time and the receiving channel for the auxiliary advertising packet, the method for advertising an extended advertising packet further includes the following step: Step S160 is performed to generate the chain advertising packet, and advertise the chain advertising packet based on the information about the receiving time and the receiving channel for the chain advertising packet, so that the Bluetooth receiving device receives the chain advertising packet based on the information about the receiving time and the receiving channel for the chain advertising packet.

The Bluetooth advertising device 10 generates the chain extended packet, and advertises the chain extended packet based on the information about the receiving time and the receiving channel for the chain extended packet. In this way, the Bluetooth receiving device 20 can subsequently receive the chain advertising packet based on the information about the receiving time and the receiving channel for the chain advertising packet that is obtained through parsing.

FIG. 5 is a schematic flowchart of scanning-based communication between a Bluetooth advertising device and a Bluetooth receiving device according to a technical solution of the present disclosure. With reference to FIG. 5, in this embodiment, the extended advertising packet is a scannable extended (Scannable Ext) advertising packet, and the auxiliary advertising packet is a scannable auxiliary (Scannable Aux) advertising packet.

Correspondingly, after the auxiliary advertising packet is advertised based on the information about the receiving time and the receiving channel for the auxiliary advertising packet, the method for advertising an extended advertising packet further includes: receiving scan request information advertised by the Bluetooth receiving device, generating a scan response corresponding to the scan request, and advertising the scan response in the receiving channel for the auxiliary advertising packet.

In a case that the extended advertising packet is a scannable extended advertising packet and the auxiliary advertising packet is a scannable auxiliary advertising packet, the Bluetooth receiving device 20 in a scanning state may transmit a corresponding scan request (SCAN_REQ) to the Bluetooth advertising device 10 after receiving the scannable extended advertising packet and the scannable auxiliary advertising packet, to request the Bluetooth advertising device 10 to transmit more advertising data.

Correspondingly, the Bluetooth advertising device 10 generates a corresponding scan response (SCAN_RSP) when receiving the scan request transmitted by the Bluetooth receiving device 20. The scan response carries more advertising data. In this way, the Bluetooth receiving device 20 can obtain more advertising data from the Bluetooth advertising device 10 based on the scan response.

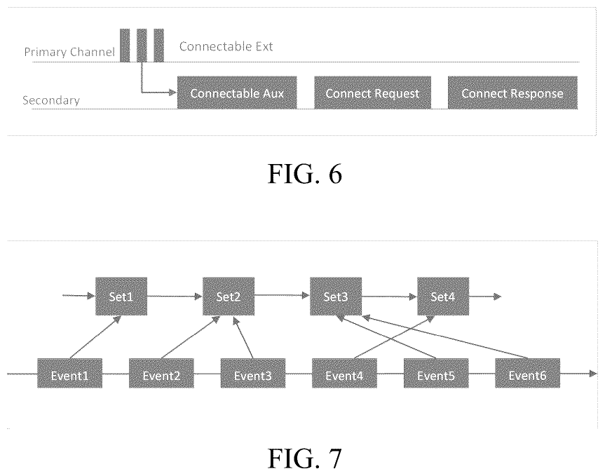

FIG. 6 is a schematic flowchart of connection-based communication between a Bluetooth advertising device and a Bluetooth receiving device according to a technical solution of the present disclosure. With reference to FIG. 6, in this embodiment, the extended advertising packet is a connectable extended (Connectable Ext) advertising packet, and the auxiliary advertising packet is a connectable auxiliary (Connectable Aux) advertising packet.

Correspondingly, after the auxiliary advertising packet is advertised based on the information about the receiving time and the receiving channel for the auxiliary advertising packet, the method for advertising an extended advertising packet further includes: receiving connect request information advertised by the Bluetooth receiving device, generating a connect response corresponding to the connect request, and advertising the connect response in the receiving channel for the auxiliary advertising packet.

In a case that the extended advertising packet is a connectable extended advertising packet and the auxiliary advertising packet is a connectable auxiliary advertising packet, the Bluetooth receiving device 20 in a connected state may transmit a corresponding connect request (CONN_REQ) to the Bluetooth advertising device 10 after receiving the connectable extended advertising packet and auxiliary advertising packet, to request the Bluetooth advertising device 10 to establish a channel connection.

Correspondingly, the Bluetooth advertising device 10 generates a corresponding connect response (CONN_RSP) when receiving the connect request transmitted by the Bluetooth receiving device 20. The connect response carries information about a connectable channel. In this way, the Bluetooth receiving device 20 establishes a channel connection to the Bluetooth advertising device 10 through the connectable channel in the connect response, so that the Bluetooth advertising device 10 can transmit more advertising data to the Bluetooth receiving device 20 through a connection channel between the Bluetooth advertising device 10 and the Bluetooth receiving device 20.

Correspondingly, embodiments of the present disclosure further provide a method for receiving an extended advertising packet.

Still with reference to FIG. 1 to FIG. 4, a method for receiving an extended advertising packet is applicable to the Bluetooth receiving device 20, and may specifically include the following steps:
Step S210: Obtain an extended advertising packet that is advertised by a Bluetooth advertising device in a primary advertising channel, the extended advertising packet carrying information about receiving time and a receiving channel for an auxiliary advertising packet.
Step S220: Parse the extended advertising packet to obtain the information about the receiving time and the receiving channel for the auxiliary advertising packet that is carried in the extended advertising packet.
Step S230: Receive the auxiliary advertising packet based on the information about the receiving time and the receiving channel for the auxiliary advertising packet that is obtained through parsing.

With reference to FIG. 1 to FIG. 4, step S210 is performed to obtain the extended advertising packet that is advertised by the Bluetooth advertising device in the primary advertising channel, the extended advertising packet carrying the information about the receiving time and the receiving channel for the auxiliary advertising packet.

The Bluetooth receiving device 20 receives the extended advertising packet, to provide a basis for parsing, by the Bluetooth receiving device 20, the extended advertising packet to obtain the information about the receiving time and the receiving channel for the auxiliary advertising packet that is carried in the extended advertising packet.

The extended advertising packet, also referred to as an extended advertising protocol data component (Ext Adv PDU), is an extended advertising packet advertised in the primary advertising physical channel. The primary advertising physical channel includes a channel 37, a channel 38, and a channel 39 of available Bluetooth advertising physical channels.

Correspondingly, the Bluetooth receiving device 20 monitors the primary advertising physical channel to obtain the extended advertising packet. In this embodiment, the primary advertising physical channel includes the channel 37, the channel 38, and the channel 39. Correspondingly, the Bluetooth receiving device 20 monitors the channel 37, the channel 38, and the channel 39 to obtain the extended advertising packet.

With reference to FIG. 1 to FIG. 4, step S220 is performed to parse the extended advertising packet to obtain the information about the receiving time and the receiving channel for the auxiliary advertising packet that is carried in the extended advertising packet.

The Bluetooth receiving device 20 parses the extended advertising packet to obtain the information about the receiving time and the receiving channel for the auxiliary advertising packet that is carried in the extended advertising packet, to subsequently receive the auxiliary advertising packet based on the information about the receiving time and the receiving channel for the auxiliary advertising packet that is obtained through parsing.

In this embodiment, the extended advertising packet carries the information about the receiving time and the receiving channel for the auxiliary advertising packet. Specifically, the extended advertising packet includes a first Aux Ptr field, and the first Aux Ptr field is used for identifying the information about the receiving time and the receiving channel for the auxiliary advertising packet.

Correspondingly, the Bluetooth receiving device 20 parses the received extended advertising packet to obtain information in the first Aux Ptr field in the extended advertising packet, to obtain the information about the receiving time and the receiving channel for the auxiliary advertising packet.

In this embodiment, the extended advertising packet further includes an Extended Header field, and the first Aux Ptr field is set in the Extended Header field of the extended advertising packet. Correspondingly, the Bluetooth receiving device 20 can quickly obtain the information about the receiving time and the receiving channel for the auxiliary advertising packet by parsing the Extended Header field of the extended advertising packet.

Specifically, the first Aux Ptr field is set in an Extended Header field in a Payload field of the auxiliary advertising packet. Correspondingly, the Bluetooth receiving device 20 can quickly obtain information about receiving time and a receiving channel for a synchronous advertising packet by parsing the Extended Header field in the Payload field of the auxiliary advertising packet.

In this embodiment, in the first Aux Ptr field, the receiving time for the auxiliary advertising packet that is carried in the extended advertising packet is identified by both a first Offset Components field and a first Aux Offset field. Specifically, the first Offset Components field is used for identifying duration of an offset component, and the first Aux Offset field is used for identifying the number of offset components in an interval between the receiving time for the auxiliary advertising packet and receiving time for the extended advertising packet.

Correspondingly, the Bluetooth receiving device 20 may obtain the receiving time for the auxiliary advertising packet by adding the receiving time for the extended advertising packet to a product of a value of the first Offset Components field and a value of the first Aux Offset field.

In this embodiment, in the first Aux Ptr field, the receiving channel for the auxiliary advertising packet in the extended advertising packet is identified by a first Channel Index field. Specifically, the first Channel Index field is used for identifying information about a channel index of the receiving channel for the auxiliary advertising packet.

Correspondingly, the Bluetooth receiving device 20 may determine the receiving channel for the auxiliary advertising packet based on a value of the channel index in the first Channel Index field in the first Aux Ptr field and a correspondence between the channel index and an advertising physical channel.

With reference to FIG. 1 to FIG. 4, step S230 is performed to receive the auxiliary advertising packet based on the information about the receiving time and the receiving channel for the auxiliary advertising packet that is obtained through parsing.

The extended advertising packet carries the information about the receiving time and the receiving channel for the auxiliary advertising packet. Correspondingly, the Bluetooth receiving device 20 may determine, based on the information about the receiving time and the receiving channel for the auxiliary advertising packet that is obtained by parsing the extended advertising packet, that a type of a to-be-received extended advertising packet is an auxiliary advertising packet, and may determine receiving time and a receiving channel for the to-be-received auxiliary advertising packet, to improve accuracy for receiving the auxiliary advertising packet.

In addition, the extended advertising packet carries the information about the receiving time and the receiving channel for the auxiliary advertising packet, so that the Bluetooth receiving device 20 can accurately identify a location of the to-be-received auxiliary advertising packet. This helps minimize time consumption and bandwidth consumption of the Bluetooth receiving device 20 that are caused by scanning the auxiliary advertising packet, and correspondingly, helps further reduce receiving power consumption of the Bluetooth receiving device 20.

In this embodiment, after obtaining the information about the receiving time and the receiving channel for the auxiliary advertising packet, the Bluetooth receiving device 20 determines an allowed receiving time limit for the auxiliary advertising packet based on the receiving time for the auxiliary advertising packet, and monitors a corresponding receiving channel within the allowed receiving time limit for the auxiliary advertising packet, to receive the auxiliary advertising packet.

Specifically, the allowed receiving time limit for the auxiliary advertising packet starts at a time point earlier than the receiving time for the auxiliary advertising packet that is obtained by parsing the extended advertising packet, and ends at a time point later than the receiving time for the auxiliary advertising packet that is obtained by parsing the extended advertising packet.

A time deviation between the time point earlier than the receiving time for the auxiliary advertising packet that is obtained by parsing the extended advertising packet and the receiving time for the auxiliary advertising packet that is obtained by parsing the extended advertising packet, and a time deviation between the time point later than the receiving time for the auxiliary advertising packet that is obtained by parsing the extended advertising packet and the receiving time for the auxiliary advertising packet that is obtained by parsing the extended advertising packet may be set according to an actual requirement. This is not limited herein.

The Bluetooth receiving device 20 determines the allowed receiving time limit for the auxiliary advertising packet based on the receiving time for the auxiliary advertising packet, and monitors the corresponding receiving channel within the allowed receiving time limit for the auxiliary advertising packet, to increase a receiving success rate for the auxiliary advertising packet.

In an extended advertising mode based on the extended advertising packet in the primary advertising physical channel and the auxiliary advertising packet, in a secondary advertising physical channel, to which the extended advertising packet is directed, an amount of advertising data of the Bluetooth advertising device 10 and an amount of advertising data of the Bluetooth receiving device 20 are equal to an amount of advertising data carried in the extended advertising packet plus an amount of advertising data carried in the auxiliary advertising packet. This can increase a data amount in Bluetooth communication.

Still with reference to FIG. 1 to FIG. 4, in this embodiment, the auxiliary advertising packet further carries information about receiving time and a receiving channel for a synchronous (Sync) extended advertising packet.

Correspondingly, after the auxiliary advertising packet is successfully received, the method for receiving an extended advertising packet further includes the following step: Step S240 is performed to parse the auxiliary advertising packet to obtain the information about the receiving time and the receiving channel for the synchronous advertising packet that is carried in the auxiliary advertising packet.

The Bluetooth receiving device 20 parses the auxiliary advertising packet to obtain the information about the receiving time and the receiving channel for the synchronous advertising packet that is carried in the auxiliary advertising packet, to subsequently receive the synchronous advertising packet based on the information about the receiving time and the receiving channel for the synchronous advertising packet that is obtained through parsing.

The synchronous advertising packet, also referred to as a synchronous advertising protocol data component (Sync Adv PDU), is a type of periodic advertising packet, and is used for transmitting information related to a broadcast isochronous group (BIG) and assisting in isochronous synchronization of a plurality of broadcast isochronous streams (BISs) in the broadcast isochronous group.

A periodic advertising connection may be established between the Bluetooth advertising device 10 and the Bluetooth receiving device 20 by using the synchronous advertising packet, so that the Bluetooth advertising device 10 can periodically transmit advertising data to the Bluetooth receiving device 20, and the Bluetooth receiving device 20 can obtain more advertising data from the Bluetooth advertising device 10.

In this embodiment, the auxiliary advertising packet includes a Sync Info field, and the Sync Info field is used for identifying the information about the receiving time and the receiving channel for the synchronous advertising packet.

Correspondingly, the Bluetooth receiving device 20 parses the received auxiliary advertising packet to obtain information in the Sync Info field in the auxiliary advertising packet, to obtain the information about the receiving time and the receiving channel for the synchronous advertising packet.

Specifically, the Sync Info field is set in an Extended Header field in a Payload field of the auxiliary advertising packet. Correspondingly, the Bluetooth receiving device 20 can quickly obtain the information about the receiving time and the receiving channel for the synchronous advertising packet by parsing the Extended Header field of the auxiliary advertising packet.

In this embodiment, in the Sync Info field, the receiving time for the synchronous advertising packet that is carried in the auxiliary advertising packet is identified by both a second Offset Components field and a second Aux Offset field. The second Offset Components field in the auxiliary advertising packet is used for identifying duration of an offset component, and the second Aux Offset field in the auxiliary advertising packet is used for identifying the number of offset components in an interval between the receiving time for the auxiliary advertising packet and the receiving time for the extended advertising packet.

Correspondingly, the Bluetooth receiving device 20 may obtain the receiving time for the synchronous advertising packet by adding the receiving time for the auxiliary advertising packet to a product of a value of the second Offset Components field and a value of the second Aux Offset field.

In this embodiment, the Sync Info field includes a second Channel Index field, and the receiving channel for the synchronous advertising packet in the auxiliary advertising packet is included in the second Channel Index field. Correspondingly, the Bluetooth receiving device 20 may determine the receiving channel for the synchronous advertising packet based on a value of a channel index in the second Channel Index field and a correspondence between the channel index and an advertising physical channel.

Still with reference to FIG. 1 to FIG. 4, in this embodiment, after the auxiliary advertising packet is parsed to obtain the information about the receiving time and the receiving channel for the synchronous advertising packet that is carried in the auxiliary advertising packet, the method for receiving an extended advertising packet further includes the following step: Step S250 is performed to receive the synchronous advertising packet based on the information about the receiving time and the receiving channel for the synchronous advertising packet that is obtained through parsing.

The Bluetooth receiving device 20 receives the synchronous advertising packet based on the information about the receiving time and the receiving channel for the synchronous advertising packet that is obtained through parsing. In this way, the Bluetooth receiving device 20 may determine, based on the information about the receiving time and the receiving channel for the synchronous advertising packet that is obtained by parsing the auxiliary advertising packet, that a type of a to-be-received extended advertising packet is a synchronous advertising packet, and may determine receiving time and a receiving channel for the to-be-received synchronous advertising packet, to improve accuracy for receiving the synchronous advertising packet.

In addition, the auxiliary advertising packet carries the information about the receiving time and the receiving channel for the synchronous advertising packet, so that the Bluetooth receiving device 20 can accurately identify a location of the to-be-received synchronous advertising packet. This helps minimize time consumption and bandwidth consumption of the Bluetooth receiving device 20 that are caused by scanning the synchronous advertising packet, and correspondingly, helps further reduce receiving power consumption of the Bluetooth receiving device 20.

In this embodiment, after obtaining the information about the receiving time and the receiving channel for the synchronous advertising packet, the Bluetooth receiving device 20 determines a receiving time limit for the synchronous advertising packet based on the receiving time for the synchronous advertising packet, and monitors a corresponding receiving channel within the allowed receiving time limit for the synchronous advertising packet, to receive the synchronous advertising packet.

Specifically, the allowed receiving time limit for the synchronous advertising packet starts at a time point earlier than the receiving time for the synchronous advertising packet that is obtained by parsing the auxiliary advertising packet, and ends at a time point later than the receiving time for the synchronous advertising packet that is obtained by parsing the auxiliary advertising packet.

Correspondingly, the Bluetooth receiving device 20 determines the allowed receiving time limit for the synchronous advertising packet based on the receiving time for the synchronous advertising packet, and monitors the corresponding receiving channel within the allowed receiving time limit for the synchronous advertising packet, to increase a receiving success rate for the synchronous advertising packet.

A time deviation between the time point earlier than the receiving time for the synchronous advertising packet that is obtained by parsing the auxiliary advertising packet and the receiving time for the synchronous advertising packet that is obtained by parsing the auxiliary advertising packet, and a time deviation between the time point later than the receiving time for the synchronous advertising packet that is obtained by parsing the auxiliary advertising packet and the receiving time for the synchronous advertising packet that is obtained by parsing the auxiliary advertising packet may be set according to an actual requirement. This is not limited herein.

In an extended advertising mode based on the extended advertising packet in the primary advertising physical channel, the auxiliary advertising packet, in the secondary advertising physical channel, to which the extended advertising packet is directed, and the synchronous advertising packet to which the auxiliary advertising packet is directed, an amount of advertising data transmitted between the Bluetooth advertising device 10 and the Bluetooth receiving device 20 can be further increased.

Still with reference to FIG. 1 to FIG. 4, in this embodiment, the auxiliary advertising packet further carries information about receiving time and a receiving channel for a chain extended advertising packet.

Correspondingly, after the auxiliary advertising packet is successfully received, the method for receiving an extended advertising packet further includes the following step: Step S260 is performed to parse the auxiliary advertising packet to obtain the information about the receiving time and the receiving channel for the chain advertising packet that is carried in the auxiliary advertising packet.

The Bluetooth receiving device 20 parses the auxiliary advertising packet to obtain the information about the receiving time and the receiving channel for the chain advertising packet that is carried in the auxiliary advertising packet, to subsequently receive the chain advertising packet based on the information about the receiving time and the receiving channel for the chain advertising packet that is obtained through parsing.

The chain advertising packet, also referred to as a chain advertising protocol data component (Chain Adv PDU), is used for constituting a chain packet together with the extended advertising packet and the auxiliary advertising packet to which the extended advertising packet is directed, to carry more advertising data. In this way, a larger amount of advertising data can be transmitted between the Bluetooth advertising device 10 and the Bluetooth receiving device 20.

In this embodiment, the auxiliary advertising packet includes a second Aux Ptr field, and the second Aux Ptr field is used for identifying the information about the receiving time and the receiving channel for the chain advertising packet.

Correspondingly, the Bluetooth receiving device 20 parses the received auxiliary advertising packet to obtain information in the second Aux Ptr field in the auxiliary advertising packet, to obtain the information about the receiving time and the receiving channel for the chain advertising packet.

Specifically, the second Aux Ptr field is set in an Extended Header field in a Payload field of the auxiliary advertising packet.

In this embodiment, in the second Aux Ptr field, the receiving time for the chain advertising packet that is carried in the auxiliary advertising packet is identified by a third Offset Components field and a third Aux Offset field. Specifically, the third Offset Components field is used for identifying duration of an offset component, and the third Aux Offset field is used for identifying the number of offset components in an interval between the receiving time for the chain advertising packet and the receiving time for the auxiliary advertising packet.

Correspondingly, the Bluetooth receiving device 20 may obtain the receiving time for the chain advertising packet by adding the receiving time for the auxiliary advertising packet to a product of a value of the third Offset Components field and a value of the third Aux Offset field.

In this embodiment, the second Aux Ptr field further includes a third Channel Index field, and information about the receiving channel for the chain advertising packet is set in the third Channel Index field in the second Aux Ptr field.

Correspondingly, the Bluetooth receiving device 20 may determine the receiving channel for the chain advertising packet based on a value of a channel index in the third Channel Index field in the second Aux Ptr field and a correspondence between the channel index and an advertising physical channel.

Still with reference to FIG. 1 to FIG. 4, in this embodiment, after the auxiliary advertising packet is parsed to obtain the information about the receiving time and the receiving channel for the chain advertising packet that is carried in the auxiliary advertising packet, the method for receiving an extended advertising packet further includes the following step: Step S270 is performed to receive the chain advertising packet based on the information about the receiving time and the receiving channel for the chain advertising packet that is obtained through parsing.

The Bluetooth receiving device 20 receives the chain advertising packet based on the information about the receiving time and the receiving channel for the chain advertising packet that is obtained through parsing. In this way, the Bluetooth receiving device 20 may determine, based on the information about the receiving time and the receiving channel for the chain advertising packet that is obtained by parsing the auxiliary advertising packet, that a type of a to-be-received extended advertising packet is a chain advertising packet, and may determine receiving time and a receiving channel for the to-be-received chain advertising packet, to improve accuracy for receiving the chain advertising packet.

The auxiliary advertising packet carries the information about the receiving time and the receiving channel for the chain advertising packet. Correspondingly, the Bluetooth receiving device 20 can accurately identify a location of the to-be-received chain advertising packet based on the information about the receiving time and the receiving channel for the chain advertising packet that is obtained by parsing the auxiliary advertising packet. This helps minimize time consumption and bandwidth consumption of the Bluetooth receiving device 20 that are caused by scanning the chain advertising packet, and correspondingly, helps further reduce receiving power consumption of the Bluetooth receiving device 20.

In this embodiment, after obtaining the information about the receiving time and the receiving channel for the chain advertising packet, the Bluetooth receiving device 20 determines an allowed receiving time limit for the chain advertising packet based on the receiving time for the chain advertising packet, and monitors a corresponding receiving channel within the allowed receiving time limit for the chain advertising packet, to receive the chain advertising packet.

Specifically, the allowed receiving time limit for the chain advertising packet starts at a time point earlier than the receiving time for the chain advertising packet that is obtained by parsing the auxiliary advertising packet, and ends at a time point later than the receiving time for the chain advertising packet that is obtained by parsing the auxiliary advertising packet. A time deviation between the time point earlier than the receiving time for the chain advertising packet that is obtained by parsing the auxiliary advertising packet and the receiving time for the chain advertising packet that is obtained by parsing the auxiliary advertising packet, and a time deviation between the time point later than the receiving time for the chain advertising packet that is obtained by parsing the auxiliary advertising packet and the receiving time for the chain advertising packet that is obtained by parsing the auxiliary advertising packet may be set according to an actual requirement. This is not limited herein.

Correspondingly, the Bluetooth receiving device 20 monitors a corresponding secondary advertising physical channel within the allowed receiving time limit for the chain advertising packet that is determined based on the receiving time for the chain advertising packet, to increase a receiving success rate for the chain advertising packet.

In an extended advertising mode based on the extended advertising packet in the primary advertising physical channel, the auxiliary advertising packet, in the secondary advertising physical channel, to which the extended advertising packet is directed, and the chain advertising packet to which the auxiliary advertising packet is directed, an amount of data transmitted between the Bluetooth advertising device 10 and the Bluetooth receiving device 20 can be further increased.

One or more chain advertising packets may exist according to a transmission requirement of advertising data.

In a case that one chain advertising packet exists, the receiving channel for the chain advertising packet may be the same as the receiving channel for the auxiliary advertising packet, or the receiving channel for the chain advertising packet may be the same as the receiving channel for the synchronous advertising packet, or the receiving channel for the chain advertising packet is different from the receiving channel for the auxiliary advertising packet and the receiving channel for the synchronous advertising packet.

In some implementations, in a case that a plurality of chain advertising packets exist, receiving channels for some of the chain advertising packets may be the same as the receiving channel for the auxiliary advertising packet, and a receiving channel for a remaining chain advertising packet is the same as the receiving channel for the synchronous advertising packet.

In other embodiments, the auxiliary advertising packet may alternatively carry only the information about the receiving time and the receiving channel for the synchronous advertising packet, or the auxiliary advertising packet may alternatively carry only the information about the receiving time and the receiving channel for the chain advertising packet. This is not limited.

Correspondingly, the method for receiving an extended advertising packet in embodiments of the present disclosure may alternatively include only steps S240 and S250, or may include only steps S260 and S270.

With reference to FIG. 5, in this embodiment, the extended advertising packet is a scannable extended (Scannable Ext) advertising packet, and the auxiliary advertising packet is a scannable auxiliary (Scannable Aux) advertising packet.

Correspondingly, after the auxiliary advertising packet is successfully received, the method for receiving an extended advertising packet further includes: generating a scan request, and advertising the scan request in the receiving channel for the auxiliary advertising packet.

In a case that the extended advertising packet is a scannable extended advertising packet and the auxiliary advertising packet is a scannable auxiliary advertising packet, the Bluetooth receiving device 20 in a scanning state may transmit a corresponding scan request (SCAN_REQ) to the Bluetooth advertising device 10 after receiving the scannable extended advertising packet and the scannable auxiliary advertising packet, to request the Bluetooth advertising device 10 to transmit more advertising data.

With reference to FIG. 5, in this embodiment, after the scan request is generated and the scan request is advertised in the receiving channel for the auxiliary advertising packet, the method for receiving an extended advertising packet further includes: receiving a scan response advertised by the Bluetooth advertising device in the receiving channel for the auxiliary advertising packet.

After the Bluetooth receiving device 20 generates the scan request and advertises the scan request in the receiving channel for the auxiliary advertising packet, the Bluetooth advertising device 10 generates a corresponding scan response (SCAN_RSP) when receiving the scan request transmitted by the Bluetooth receiving device 20. The scan response carries more advertising data. In this way, the Bluetooth receiving device 20 can obtain more advertising data from the Bluetooth advertising device 10 based on the scan response.

Correspondingly, the Bluetooth receiving device 20 can obtain more advertising data from the scan response by receiving the scan response and parsing the scan response.

With reference to FIG. 6, in this embodiment, the extended advertising packet is a connectable extended (Connectable Ext) advertising packet, and the auxiliary advertising packet is a connectable auxiliary (Connectable Aux) advertising packet.

Correspondingly, after the auxiliary advertising packet is advertised based on the information about the receiving time and the receiving channel for the auxiliary advertising packet, the method for advertising an extended advertising packet further includes: generating a connect request (CONN_REQ), and advertising the connect request in the receiving channel for the auxiliary advertising packet.

In a case that the extended advertising packet is a connectable extended advertising packet and the auxiliary advertising packet is a connectable auxiliary advertising packet, the Bluetooth receiving device 20 in a connected state transmits a corresponding connect request to the Bluetooth advertising device 10 after receiving the connectable extended advertising packet and auxiliary advertising packet, to request to establish a connection to the Bluetooth advertising device 10.

Correspondingly, the Bluetooth advertising device 10 generates a corresponding connect response (CONN_RSP) when receiving the connect request transmitted by the Bluetooth receiving device 20. In this way, the Bluetooth receiving device 20 establishes a connection to the Bluetooth advertising device 10 after receiving the connect response, and receives, through an established connection channel, more data transmitted by the Bluetooth advertising device 10.

In this embodiment, in a case that the auxiliary advertising packet is successfully received, the method for receiving an extended advertising packet further includes: obtaining information about a corresponding belong-to advertising set based on information about receiving time, a receiving channel, and a protocol data component type for at least one of the extended advertising packet and the auxiliary advertising packet.

The Bluetooth receiving device 20 may simultaneously enable a plurality of advertising sets according to an actual requirement, and data types of the advertising sets are different. The advertising sets of the Bluetooth receiving device 20 may be created by a data link layer or a Bluetooth application at an application layer to meet different data requirements of the data link layer and the Bluetooth application at the application layer.

With reference to FIG. 7, in an example, the Bluetooth receiving device 20 has an advertising set 1, an advertising set 2, an advertising set 3, and an advertising set 4. Each of advertising events 1 to 6 corresponds to receiving of an extended advertising packet.

In a case that a plurality of advertising sets on the Bluetooth receiving device 20 simultaneously receive data, an advertising set to which a received advertising packet belongs needs to be determined, so that a corresponding advertising set creator can accurately obtain required advertising data.

In this embodiment, a correspondence between an advertising set and information about receiving time, a receiving channel, and a protocol data component type of an auxiliary advertising packet is stored on the Bluetooth receiving device 20.

Correspondingly, in a case that a plurality of advertising sets exist, the Bluetooth receiving device 20 can determine, based on the correspondence that is stored on the Bluetooth receiving device 20 and that is between an advertising set and information about receiving time, a receiving channel, and a protocol data component type of an auxiliary advertising packet, information about advertising sets to which a received auxiliary advertising packet and a synchronous advertising packet and/or a chain advertising packet to which the auxiliary advertising packet is directed belong.

In other embodiments, a correspondence between an advertising set and information about receiving time, a receiving channel, and a protocol data component type of an extended advertising packet may alternatively be stored on the Bluetooth receiving device. Correspondingly, the Bluetooth receiving device can determine, based on the correspondence between an advertising set and information about receiving time, a receiving channel, and a protocol data component type of an extended advertising packet, information about advertising sets to which an auxiliary advertising packet to which the extended advertising packet is directed and a synchronous advertising packet and/or a chain advertising packet to which the auxiliary advertising packet is directed belong.

In other embodiments, both a correspondence between an advertising set and information about receiving time, a receiving channel, and a protocol data component type of an extended advertising packet and a correspondence between an advertising set and information about receiving time, a receiving channel, and a protocol data component type of an auxiliary advertising packet may alternatively be stored on the Bluetooth receiving device. Correspondingly, the Bluetooth receiving device can determine, based on the correspondence between an advertising set and information about receiving time, a receiving channel, and a protocol data component type of an extended advertising packet and the correspondence between an advertising set and information about receiving time, a receiving channel, and a protocol data component type of an auxiliary advertising packet, information about advertising sets to which the auxiliary advertising packet and a synchronous advertising packet and/or a chain advertising packet to which the auxiliary advertising packet is directed belong.

Still with reference to FIG. 7, in this embodiment, after the information about the corresponding belong-to advertising set is obtained based on the information about the receiving time, the receiving channel, and the protocol data component type for at least one of the extended advertising packet and the auxiliary advertising packet, the method for receiving an extended advertising packet further includes: receiving, by using the corresponding belong-to advertising set, the auxiliary advertising packet and the synchronous advertising packet and/or the chain advertising packet to which the auxiliary advertising packet is directed.

The Bluetooth receiving device 20 receives, by using the corresponding belong-to advertising set, the auxiliary advertising packet and at least one of the synchronous advertising packet and the chain advertising packet to which the auxiliary advertising packet is directed. In this way, the auxiliary advertising packet and the synchronous advertising packet and/or the chain advertising packet to which the auxiliary advertising packet is directed can be accurately received, so that a corresponding advertising set creator can accurately obtain required advertising data.

In this embodiment, after the receiving of the auxiliary advertising packet and the synchronous advertising packet and/or the chain advertising packet to which the auxiliary advertising packet is directed succeeds or fails, the method for receiving an extended advertising packet further includes: transmitting advertising packet receiving result prompt information to a corresponding advertising set creator based on receiving results for the extended advertising packet, the auxiliary advertising packet, and at least one of the synchronous advertising packet and the chain advertising packet.

Advertising packet receiving result prompt information is transmitted to a corresponding advertising set creator based on receiving results for the auxiliary advertising packet to which the extended advertising packet is directed and at least one of the synchronous advertising packet and the chain advertising packet to which the auxiliary advertising packet is directed. In this way, the corresponding advertising set creator can take corresponding measures, for example, continue receiving or end receiving, based on the receiving results for the auxiliary advertising packet to which the extended advertising packet is directed and at least one of the synchronous advertising packet and the chain advertising packet to which the auxiliary advertising packet is directed.

Correspondingly, embodiments of the present disclosure further provide a Bluetooth advertising device.

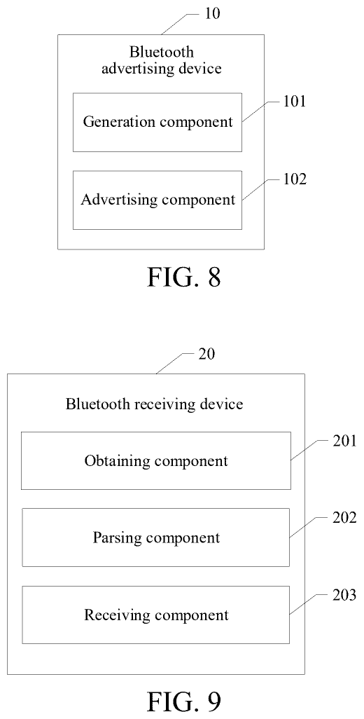

FIG. 8 is a schematic structural diagram of an embodiment of a Bluetooth advertising device according to a technical solution of the present disclosure. With reference to FIG. 8, a Bluetooth advertising device 10 may include: a generation component 101, configured to generate an extended advertising packet, the extended advertising packet carrying information about receiving time and a receiving channel for an auxiliary advertising packet; and an advertising component 102, configured to advertise the extended advertising packet in a primary advertising physical channel, so that in the case of successfully receiving the extended advertising packet, a Bluetooth receiving device parses the extended advertising packet to obtain the information about the receiving time and the receiving channel for the auxiliary advertising packet that is carried in the extended advertising packet, and receives the auxiliary advertising packet based on the information about the receiving time and the receiving channel for the auxiliary advertising packet that is obtained through parsing.

The Bluetooth advertising device in this embodiment of the present disclosure may be configured to perform the foregoing method for advertising an extended advertising packet, or the foregoing method for advertising an extended advertising packet may be performed by another apparatus. For the method for advertising an extended advertising packet, refer to the detailed descriptions in the foregoing part. Details are not described herein again.

Correspondingly, embodiments of the present disclosure further provide a Bluetooth receiving device.

FIG. 9 is a schematic structural diagram of an embodiment of a Bluetooth receiving device according to a technical solution of the present disclosure. With reference to FIG. 9, a Bluetooth receiving device 20 may include: an obtaining component 201, configured to monitor a primary advertising physical channel to obtain an extended advertising packet that is advertised by a Bluetooth advertising device, the extended advertising packet carrying information about receiving time and a receiving channel for an auxiliary advertising packet; a parsing component 202, configured to parse the extended advertising packet to obtain the information about the receiving time and the receiving channel for the auxiliary advertising packet that is carried in the extended advertising packet; and a receiving component 203, configured to receive the auxiliary advertising packet based on the information about the receiving time and the receiving channel for the auxiliary advertising packet that is obtained through parsing.

The Bluetooth receiving device in this embodiment of the present disclosure may be configured to perform the foregoing method for receiving an extended advertising packet, or the foregoing method for receiving an extended advertising packet may be performed by another apparatus. For the method for receiving an extended advertising packet, refer to the detailed descriptions in the foregoing part. Details are not described herein again.

Correspondingly, embodiments of the present disclosure further provide an electronic device, including at least one memory and at least one processor. The memory stores one or more computer instructions. The one or more computer instructions are executed by the processor to implement the method for advertising an extended advertising packet or the method for receiving an extended advertising packet in embodiments of the present disclosure. For the method for advertising an extended advertising packet or the method for receiving an extended advertising packet in embodiments of the present disclosure, refer to the detailed descriptions in the foregoing part. Details are not described herein again.

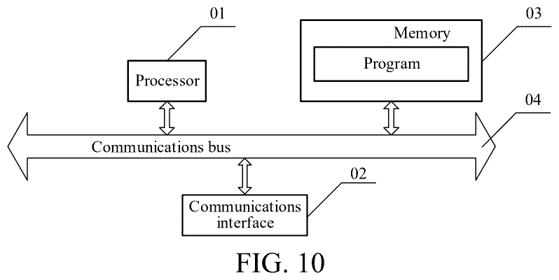

An exemplary hardware structure of an electronic device provided in embodiments of the present disclosure may be shown in FIG. 10. The electronic device includes at least one processor 01, at least one communications interface 02, at least one memory 03, and at least one communications bus 04.

In embodiments of the present disclosure, at least one processor 01, at least one communications interface 02, at least one memory 03, and at least one communications bus 04 exist, and the processor 01, the communications interface 02, and the memory 03 communicate with each other through the communications bus 04.

The communications interface 02 may be an interface of a communications circuit used for network communication, for example, an interface of a GSM circuit.

The processor 01 may be a central processing component (CPU), an application-specific integrated circuit (ASIC), or one or more integrated circuits configured to implement embodiments of the present disclosure.

The memory 03 may include a high-speed RAM, or may include a non-volatile memory, for example, at least one disk memory.

The memory 03 stores one or more computer instructions. The one or more computer instructions are executed by the processor 01 to implement the method for advertising an extended advertising packet or the method for receiving an extended advertising packet in embodiments of the present disclosure.

The terminal device implemented above may further include other components (not shown) that may not be necessary for the content disclosed in embodiments of the present disclosure. These other components may not be necessary for understanding the content disclosed in embodiments of the present disclosure, and therefore are not described one by one in embodiments of the present disclosure.

Embodiments of the present disclosure further provide a storage medium. The storage medium stores one or more computer instructions. The one or more computer instructions are used for implementing the method for advertising an extended advertising packet or the method for receiving an extended advertising packet in embodiments of the present disclosure.

The implementations of the present disclosure described above are a combination of elements and features of the present disclosure. The elements or features may be considered selective unless otherwise mentioned. The elements or features may be implemented without being combined with other elements or features. In addition, the implementations of the present disclosure may be configured by combining some elements and/or features. The order of operations described in the implementations of the present disclosure may be rearranged. Some configurations of any implementation may be included in another implementation and may be replaced with corresponding configurations of another implementation. It is obvious to a person skilled in the art that claims that do not have a clear reference relationship with each other may be combined into an implementation of the present disclosure, or may be included as new claims in amendments after the filing of this application.

In an example, the implementations of the present disclosure may be implemented by various means such as hardware, firmware, software, or a combination thereof. In a hardware configuration mode, the method according to the exemplary embodiments of the present disclosure may be implemented by one or more application-specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like.

In a firmware or software configuration mode, the implementations of the present disclosure may be implemented in the form of circuits, processes, functions, and the like. Software code may be stored in a memory component and executed by a processor. The memory component is located inside or outside the processor and can transmit data to and receive data from the processor by various known means.

The foregoing descriptions of the disclosed embodiments enable a person skilled in the art to implement or use the present disclosure. Various modifications to these embodiments are obvious to a person skilled in the art, and the general principles defined in this specification may be implemented in other embodiments without departing from the spirit or scope of the present disclosure. Therefore, the present disclosure is not limited to these embodiments illustrated herein, but conforms to the broadest scope consistent with the principles and novel features disclosed in the present disclosure.

Although the present disclosure is disclosed above, the present disclosure is not limited thereto. A person skilled in the art can make various changes and modifications without departing from the spirit and the scope of the present disclosure. Therefore, the protection scope of the present disclosure shall be subject to the scope defined by the claims.

1. A method for advertising an extended advertising packet, applicable to a Bluetooth advertising device, and comprising:
generating an extended advertising packet, the extended advertising packet carrying information about receiving time and a receiving channel for an auxiliary advertising packet;
advertising the extended advertising packet in a primary advertising physical channel, so that in the case of successfully receiving the extended advertising packet, a Bluetooth receiving device parses the extended advertising packet to obtain the information about the receiving time and the receiving channel for the auxiliary advertising packet that is carried in the extended advertising packet;
generating the auxiliary advertising packet; and
advertising the auxiliary advertising packet based on the information about the receiving time and the receiving channel for the auxiliary advertising packet, so that the Bluetooth receiving device receives the auxiliary advertising packet based on the information about the receiving time and the receiving channel for the auxiliary advertising packet that is obtained by parsing the extended advertising packet.

2. The method for advertising an extended advertising packet according to claim 1, wherein the extended advertising packet comprises a first Aux Ptr field, and the first Aux Ptr field is used for identifying the information about the receiving time and the receiving channel for the auxiliary advertising packet.

3. The method for advertising an extended advertising packet according to claim 1, wherein the auxiliary advertising packet carries information about receiving time and a receiving channel for at least one of a synchronous advertising packet and a chain advertising packet, and the advertising method further comprises at least one of the following operations:
generating the synchronous advertising packet; advertising the synchronous advertising packet based on information about receiving time and a receiving channel for the synchronous advertising packet, so that the Bluetooth receiving device receives the synchronous advertising packet based on the information about the receiving time and the receiving channel for the synchronous advertising packet;
generating the chain advertising packet; and advertising the chain advertising packet based on information about receiving time and a receiving channel for the chain advertising packet, so that the Bluetooth receiving device receives the chain advertising packet based on the information about the receiving time and the receiving channel for the chain advertising packet.

4. The method for advertising an extended advertising packet according to claim 3, wherein the auxiliary advertising packet comprises a second Aux Ptr field and a Sync Info field, the second Aux Ptr field is used for identifying the information about the receiving time and the receiving channel for the chain advertising packet, and the Sync Info field is used for identifying the information about the receiving time and the receiving channel for the synchronous advertising packet.

5. The method for advertising an extended advertising packet according to claim 3, wherein the receiving channel for the synchronous advertising packet is different from the receiving channel for the auxiliary advertising packet.

6. The method for advertising an extended advertising packet according to claim 3, wherein one or more chain advertising packets exist; and
in a case that a plurality of chain advertising packets exist, receiving channels for some or all of the chain advertising packets are the same as the receiving channel for the auxiliary advertising packet, or receiving channels for some or all of the chain advertising packets are the same as the receiving channel for the synchronous advertising packet.

7. The method for advertising an extended advertising packet according to claim 1, wherein the extended advertising packet is a scannable extended advertising packet, and the auxiliary advertising packet is a scannable auxiliary advertising packet; and
the advertising method further comprises: receiving a scan request for the auxiliary advertising packet from the Bluetooth receiving device; generating a scan response corresponding to the scan request; and advertising the scan response in the receiving channel for the auxiliary advertising packet, so that the Bluetooth receiving device receives the scan response in the receiving channel for the auxiliary advertising packet.

8. The method for advertising an extended advertising packet according to claim 1, wherein the extended advertising packet is a connectable extended advertising packet, and the auxiliary advertising packet is a scannable auxiliary advertising packet; and
the advertising method further comprises: receiving a connect request for the auxiliary advertising packet from the Bluetooth receiving device; generating a connect response corresponding to the connect request; and advertising the connect response in the receiving channel for the auxiliary advertising packet, so that the Bluetooth receiving device receives the connect response in the receiving channel for the auxiliary advertising packet.

9. A method for receiving an extended advertising packet, applicable to a Bluetooth receiving device, and comprising:
obtaining an extended advertising packet that is advertised by a Bluetooth advertising device in a primary advertising physical channel, the extended advertising packet carrying information about receiving time and a receiving channel for an auxiliary advertising packet;
parsing the extended advertising packet to obtain the information about the receiving time and the receiving channel for the auxiliary advertising packet that is carried in the extended advertising packet; and
receiving the auxiliary advertising packet based on the information about the receiving time and the receiving channel for the auxiliary advertising packet that is obtained through parsing.

10. The method for receiving an extended advertising packet according to claim 9, wherein the extended advertising packet comprises a first Aux Ptr field, and the first Aux Ptr field is used for identifying the information about the receiving time and the receiving channel for the auxiliary advertising packet.

11. The method for receiving an extended advertising packet according to claim 9, wherein the auxiliary advertising packet carries information about receiving time and a receiving channel for at least one of a synchronous advertising packet and a chain advertising packet; and
in a case that the auxiliary advertising packet is successfully received, the receiving method further comprises at least one of the following operations:
parsing the auxiliary advertising packet to obtain information about receiving time and a receiving channel for the synchronous advertising packet that is carried in the auxiliary advertising packet; receiving the synchronous advertising packet based on the information about the receiving time and the receiving channel for the synchronous advertising packet that is obtained through parsing;
parsing the auxiliary advertising packet to obtain information about receiving time and a receiving channel for the chain advertising packet; and receiving the chain advertising packet based on the information about the receiving time and the receiving channel for the chain advertising packet that is obtained through parsing.

12. The method for receiving an extended advertising packet according to claim 11, wherein the auxiliary advertising packet comprises a second Aux Ptr field and a Sync Info field, the second Aux Ptr field is used for identifying the information about the receiving time and the receiving channel for the chain advertising packet, and the Sync Info field is used for identifying the information about the receiving time and the receiving channel for the synchronous advertising packet.

13. The method for receiving an extended advertising packet according to claim 11, wherein the receiving channel for the synchronous advertising packet is different from the receiving channel for the auxiliary advertising packet.

14. The method for receiving an extended advertising packet according to claim 11, wherein one or more chain advertising packets exist; and
receiving channels for some or all of the chain advertising packets are the same as the receiving channel for the auxiliary advertising packet, or receiving channels for some or all of the chain advertising packets are the same as the receiving channel for the synchronous advertising packet.

15. The method for receiving an extended advertising packet according to claim 11, wherein in a case that the receiving channel for the chain advertising packet is the same as the receiving channel for the synchronous advertising packet, the receiving time for the chain advertising packet is later than the receiving time for the synchronous advertising packet.

16. The method for receiving an extended advertising packet according to claim 11, further comprising: obtaining, based on information about receiving time, a receiving channel, and a protocol data component type for at least one of the extended advertising packet and the auxiliary advertising packet, information about belong-to advertising sets corresponding to the auxiliary advertising packet to which the extended advertising packet is directed and at least one of the synchronous advertising packet and the chain advertising packet to which the auxiliary advertising packet is directed; and receiving, by using the corresponding belong-to advertising sets, the auxiliary advertising packet to which the extended advertising packet is directed and at least one of the synchronous advertising packet and the chain advertising packet to which the auxiliary advertising packet is directed.

17. The method for receiving an extended advertising packet according to claim 16, further comprising:
transmitting corresponding advertising packet receiving result prompt information to a corresponding advertising set creator based on receiving results for the auxiliary advertising packet to which the extended advertising packet is directed and at least one of the synchronous advertising packet and the chain advertising packet to which the auxiliary advertising packet is directed.

18. The method for receiving an extended advertising packet according to claim 9, wherein the extended advertising packet is a scannable extended advertising packet, and the auxiliary advertising packet is a scannable auxiliary advertising packet; and
in a case that the auxiliary advertising packet is successfully received, the receiving method further comprises: transmitting a corresponding scan request to the Bluetooth advertising device for the auxiliary advertising packet; and receiving a scan response corresponding to the scan request in the receiving channel for the auxiliary advertising packet.

19. The method for receiving an extended advertising packet according to claim 9, wherein the extended advertising packet is a connectable extended advertising packet, and the auxiliary advertising packet is a connectable auxiliary advertising packet; and
in a case that the auxiliary advertising packet is successfully received, the receiving method further comprises: transmitting a corresponding connect request to the Bluetooth advertising device for the auxiliary advertising packet; and receiving a connect response corresponding to the connect request in the receiving channel for the auxiliary advertising packet.

20. A communications system, comprising:
a Bluetooth advertising device comprising at least one first memory and at least one first processor, the at least one first memory storing one or more first computer instructions that, when executed by the at least one first processor, cause the at least one first processor to implement a method for advertising an extended advertising packet, the method comprising:
generating an extended advertising packet, the extended advertising packet carrying information about receiving time and a receiving channel for an auxiliary advertising packet;
advertising the extended advertising packet in a primary advertising physical channel, so that in the case of successfully receiving the extended advertising packet, a Bluetooth receiving device parses the extended advertising packet to obtain the information about the receiving time and the receiving channel for the auxiliary advertising packet that is carried in the extended advertising packet;
generating the auxiliary advertising packet; and
advertising the auxiliary advertising packet based on the information about the receiving time and the receiving channel for the auxiliary advertising packet, so that the Bluetooth receiving device receives the auxiliary advertising packet based on the information about the receiving time and the receiving channel for the auxiliary advertising packet that is obtained by parsing the extended advertising packet; and
a Bluetooth receiving device comprising at least one second memory and at least one second processor, the at least one second memory storing one or more second computer instructions that, when executed by the at least one second processor, cause the at least one second processor to implement a method for receiving the extended advertising packet, the method comprising:
obtaining the extended advertising packet that is advertised by the Bluetooth advertising device in the primary advertising physical channel, the extended advertising packet carrying information about receiving time and the receiving channel for the auxiliary advertising packet;
parsing the extended advertising packet to obtain the information about the receiving time and the receiving channel for the auxiliary advertising packet that is carried in the extended advertising packet; and
receiving the auxiliary advertising packet based on the information about the receiving time and the receiving channel for the auxiliary advertising packet that is obtained through parsing.
